(19) United States
(12) Patent Application Publication
(10) Pub. No.: US 2011/0238565 A1
(43) Pub. Date: Sep. 29, 2011

(54) SYSTEM AND METHOD FOR FINANCIALLY DISTRESSED PERSONS TO AVOID CONSEQUENCE OF FORECLOSURE

(75) Inventors: William Cznadel, Huntington Station, NY (US); Scott Casaccio, Commack, NY (US)

(73) Assignee: C & C HOMEOWNERSHIP SOLUTIONS, INC., Commack, NY (US)

(21) Appl. No.: 13/075,741

(22) Filed: Mar. 30, 2011

Related U.S. Application Data
(63) Continuation of application No. 11/893,805, filed on Aug. 17, 2007, now abandoned.

(51) Int. Cl. G06Q 40/00

(52) U.S. Cl. 705/38; 705/35

(57) ABSTRACT

A novel system, method and computer program product for enabling owner/debtor's particularly, of dwellings, e.g. single or multi-family dwellings homes, condominiums, etc. (mortgagors), who are in financial distress and may be entering into a home foreclosure, to avoid the foreclosure by enabling them to purchase another real-estate property as joint or co-owner with another debtor, e.g., who may or may not be in a similar foreclosure situation. Immediate beneficial effect of such an equity purchasing arrangement for all parties is realized when brokered and transacted according to the systems and methods of the present invention. For instance, based on pool membership and an affordability factor rating, customers may be immediately extricated from the foreclosure process, advantageously matched with another borrower using calculations provided by the invention, and placed in an equity home co-ownership situation.

This application is a continuation of U.S. Ser. No. 11/893,805, filed Aug. 17, 2007 (SSMP Docket No. 21137).

### BACKGROUND OF THE INVENTION

1. Field of the Invention

The present invention relates generally to arranging and conducting real estate transactions and particularly, to a novel computer implemented system and methods for facilitating the coordination of events designed to remove financially distressed persons who have equity in a property or home from the prospect of foreclosure, and to place them in an improved home owning situation.

2. Description of the Prior Art

In recent years, the nation has experienced what could be called a foreclosure crises. For example, the number of U.S. homes entering foreclosure in the first three months of 2007 doubled from the same period last year according to a national statistic, and actual numbers of lender filed foreclosures is increasing. Foreclosure is a lose-lose situation for the parties involved, particularly, the home owner and his/her family who face loss of a dwelling, with the attendant negative social and emotional impact, not to mention the serious negative impact on their credit rating, and loss of financial freedom, and, the lender (typically a bank) who loses a stream of income and faces the prospect of having to sell the foreclosed property.

It would be highly desirable to provide a system and method that facilitates a debtor's avoiding a foreclosure, and moreover, places the debtor in an equity owning situation and on a fast path to financial freedom, and has the advantageous benefit of stimulating the economy.

### SUMMARY OF THE INVENTION

It is an object of the present invention to provide a system and method that facilitates a debtor's avoiding a foreclosure, and moreover, places that debtor in a home owning situation thereby placing them on a fast path to financial freedom.

The present invention relates generally to real estate transactions and to novel computer implemented system and methods for arranging and conducting real estate transactions that are specifically developed to enable debtors or similar persons in financial distress and/or who are entering into foreclosure to avoid the foreclosure, in an expedited fashion. The present invention particularly enables a professional, such as a broker, lender or agent, acting to coordinate those transactions for placing financially distressed customers in equity owning situation as a co-owner, with another party, of a two-family or multi-family dwelling, in as short time as possible, or in a time frame of removing a customer from a foreclosure situation that customer is already in.

The system and methods of the invention particularly implements algorithms that facilitate the matching of such a debtor with another party, who may or may not be a similar owner of a foreclosed property, and place them into a home owning situation as legally bound co-owners of another two-family or multi-family dwelling/property/home that is available on the market, or, co-owners of the debtor's existing home.

In one aspect of the invention, after the sale of the debtor's existing home, the computer implemented systems, methods and algorithms of the invention facilitates a home purchase transaction for the debtor as a joint or co-owner with another, and, is structured such that the debtor is able to avoid foreclosure while purchasing a dwelling/property/home, preferably of equal to or greater value, than the debtor's current home in foreclosure, and, preferably, is currently available on the market in a desired location specified by the debtor.

The computer implemented systems, methods and algorithms of the invention further enable similarly financially distressed persons or, any person seeking an affordable and low risk home ownership investment, to purchase property that is further structured such that the debtor and co-owner guarantees new mortgage payments for a predetermined amount of time, e.g., 1 year.

In a further aspect, computer implemented systems and methods provide a user, i.e., a broker, agent, lender, with a graphic-based tool and user interface that employing all the necessary processing capability and functionality designed to facilitate, in real time, the investigation into and presentation of estimated and actual home equity purchase co-ownership options for the customer.

When a home owner, for example, enters into foreclosure, the present invention is activated. Upon receipt of a debtor's current financial situation, which information is entered into the system, the system automatically assigns an affordability factor rating to the debtor; from this rating and the ratings assigned to other debtors, the system advantageously matches two potential parties and initiates a search of a potential dwelling/home/property within a pre-determined goal purchase price range affordable by the debtors. This affordability factor and goal purchase price range is structured so that the debtors are always at a LTV ratio assured to entice a lender into lending to the debtors, notwithstanding their foreclosure situation.

That is, through a series of interface screens, a user (i.e., a broker, agent, lender) is walked through a process to advise transactions to advise, expedite and facilitate the coordination of a series of events designed to immediately remove a customer from the prospect of foreclosure and place them in an improved home owning situation as co-owner with another. The method and system is preferably built with a mechanism for ensuring soft parameters are addressed such as the debtor's geographic preferences as to the new ownership situation, e.g., in the same community or a community of comparable or improved socio-economic status.

In one embodiment of the invention, a lender such as a bank or credit union, may license or subscribe to or implement the system of the present invention, and will benefit from expedited procedures to place borrowers into a two- or multi-family house and remove them from a current prospect of foreclosure. This will constitute a real purchase between that borrower and new equal partner (EP) or non-equal partner (NEP).

In another advantageous embodiment, a predetermined amount of equity reserve is built in to the purchase transaction to guarantee for the lender co-owner payments for a predetermined period of time, e.g., 1-2 years. These reserves must be sufficiently estimated to ensure payment of all financial obligation associated with the co-ownership situation, e.g., traditional financial obligations including principle, interest, taxes, and insurance (PITI), should one or both of the parties default.

Advantageously, the method is designed such that the new equity owning situation is attractive to lenders, banks, and financial institutions to participate in providing financing for the parties through the reduction of loss mitigation engendered by the invention.

### BRIEF DESCRIPTION OF THE DRAWINGS

The objects, features and advantages of the present invention will become apparent to one skilled in the art, in view of the following detailed description taken in combination with the attached drawings, in which:

FIGS. 1A-1B depicts generally, a methodology for enabling a debtor, borrower or financially distressed person to avoid foreclosure from the view point of the parties including the debtor or borrower or financially distressed person according to the principles of the invention;

FIG. 2 in general depicts a novel Graphic User Interface (GUI) providing an AFQ interface screen 100 via which functionality is initiated for enabling and entering data into a system for enabling a customer to avoid foreclosure;

FIG. 3 depicts an example screen interface 200 provided by a computer device implementing the system of the present invention presented to a user to initiate investigation into a estimated and actual pools of potential partner candidates based on their estimated AF rating and their estimated equitable contribution affordable;

FIG. 3A depicts an example screen interface 200′ for an example customer having been assigned an affordability factor rating of 2.5 with the AF-1, AF-1.5 and AF-2 entry buttons grayed out;

FIGS. 4 and 6, depict a further interface screens presented to the user providing a list of those potential partners estimated (as in FIG. 4) and actual (as in FIG. 6) that could be matched with the customer based on that AF, GPP EC criteria and, other criteria including a total combined equity contributions (TCEC) criteria;

FIGS. 5 and 7 depict example interfaces presented on a benefits page that are automatically presented to the user, in response to selection of a potential candidate in an estimation phase (FIG. 5) or actual program phase (FIG. 7), details concerning the estimated potential purchase between the customer and the selected partner and the attendant benefits for the customers;

FIG. 8 depicts some of the calculations and novel table implemented as part of the process to establish the customer's AF rating, particularly based on that customer's current Debt To Income (DTI) ratio;

FIG. 9 illustrates an example worksheet 500 depicting further types of calculations automatically implemented by the system for avoiding foreclosure at the various estimation and actual phases of the program, and that may be programmed into the system computer device; and,

FIG. 10 depicts the configuration of a system 600 in which the present invention may be implemented.

### DETAILED DESCRIPTION OF THE PREFERRED EMBODIMENTS

As will be defined herein a debtor in financial distress refers to any person who is in foreclosure or has entered a pre-foreclosure proceeding and/or who has limited purchasing power, e.g., a student or retiree struggling to meet their obligations.

As referred to herein, the terms customer or customers are used interchangeably to represent the as financially distressed borrower(s) or debtor (s) or, any person who is seeking a much more affordable and low risk home ownership investment. These are usually borrowers who have no other affordable alternative as they are in foreclosure or have entered a pre-foreclosure proceeding and or is in financial distress.

Moreover, the terms “program” or “application” and the like as used herein, are defined as a sequence of instructions designed for execution on a computer system. A computer program, product or application code may include a subroutine, a function, a procedure, an object method, an object implementation, an executable application, an applet, a servlet, a source code, an object code, a shared library/dynamic load library and/or other sequence of instructions designed for execution on a computer system.

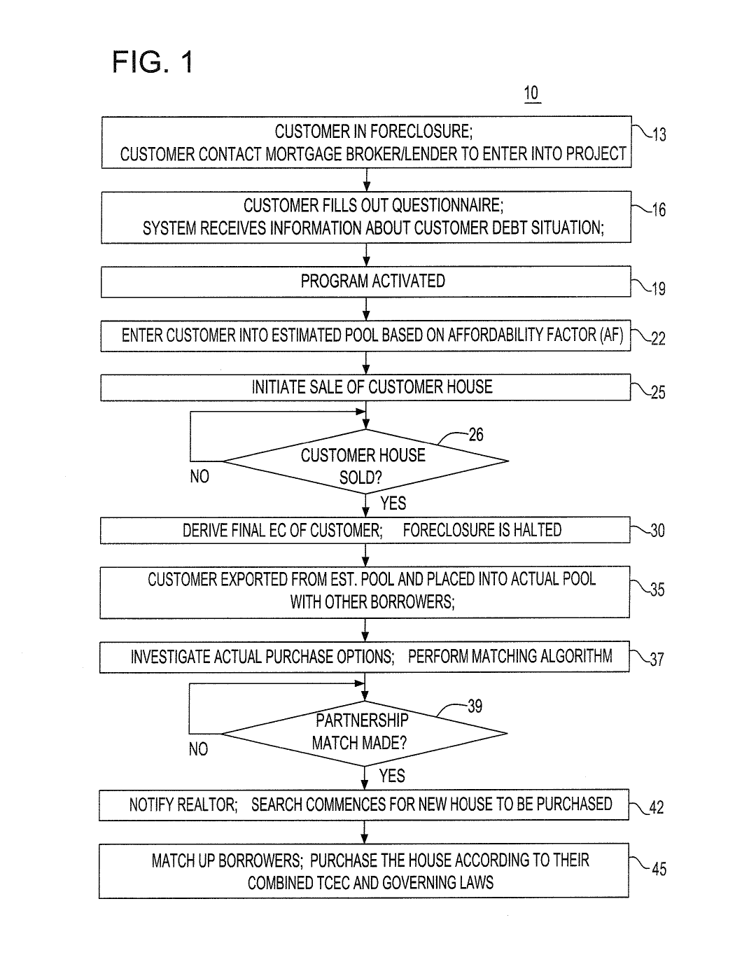

FIG. 1A is a flow chart depicting the methodology 10 of the present invention as implemented by the various parties involved in the process for enabling persons who are equity owners of property but who are in financial distress to avoid a foreclosure situation, by enabling them entering into an ownership situation as co-owner with another borrower. Particular parties include the customer or “customers” (a financially distressed borrower) who are about to enter into a foreclosure situation on their own property. As shown in FIG. 1A, at step 13, a customer/borrower who learns about the foreclosure or may have already entered a foreclosure on their dwelling, may now seek out a broker or lender, e.g., a bank, vice versa, provisioned to implement a program for providing an additional service for a customer. Alternately, a broker or lender may subscribe to a web-based service services provided by the present invention. The broker or lender will activate and execute the system and methods of the present invention. For example, as shown in FIG. 1A, at step 16, the borrower's income data and debt information are first entered into the system, for example, by filling in an affordability factor questionnaire (AFQ), in addition to other data pertaining to their current situation. Then, as a result of the user's debt information, whether used to calculate a customer's DTI ratio level, and a corresponding affordability factor (AF) rating associated with the customer and used in the analysis performed by the present invention.

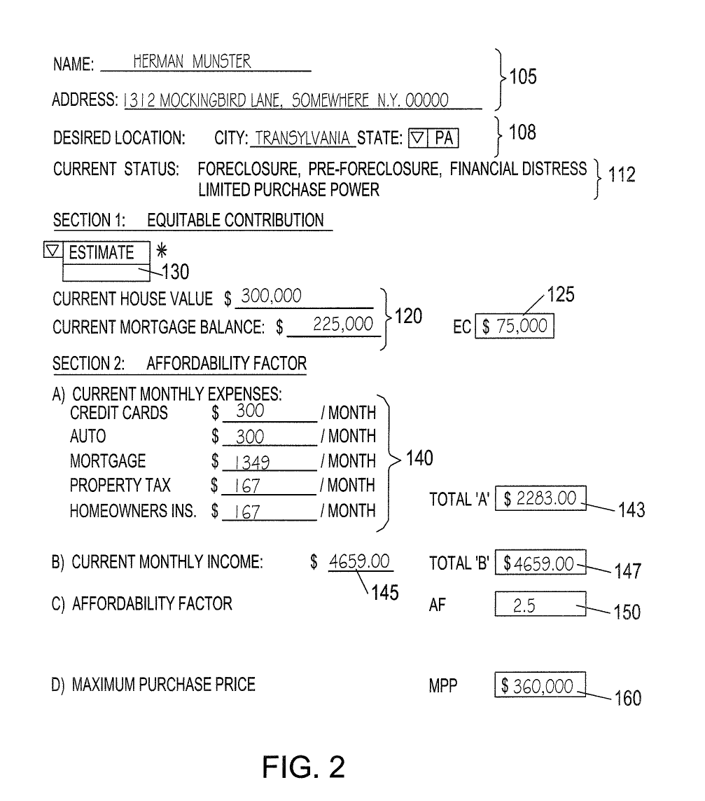

FIG. 2 depicts an example screen interface 100 provided by a computer device implementing the system of the present invention. This interface will be presented to a user (lender, agent, broker) to elicit information from the customer and enter it directly into the system, or, may be directly entered into the system by a customer. The example interface 100 comprises the AFQ comprising data entry fields for receiving information including customer's name and address 105, a geographic location 108 in which the customer prefers to purchase a new home according to the invention (e.g., a town, city, state, where the customer desires to live and which may be used as a basis for the home search purposes), the status 112 of the customer (e.g., financial distress, in foreclosure, etc.). Initially, via interface 100, additional data such as the customer's current house “market” value and current mortgage balance value 120 is entered and a calculation is performed to determine the customer's estimated Equity Contribution (EC). Particularly, the customer's estimated total EC affordable by that customer for participating in the program is calculated based on their entered current financial data, e.g., the customer's current market value minus the current mortgage balance LTV ratio and this value is populated in with the customer's estimated EC value 125 is populated in entry field 125.

The screen interface 100 of FIG. 2, is further provided with a program phase selector button 130 to indicate on the screens for the user that all calculations and displayed values are estimated values (in the estimation phase of the program) or actual values. In the interface depicted in FIGS. 2-5 these program phase selector button 130 is selected with screens displaying only estimated values. Once an actual sale of the foreclosed home or home about to enter foreclosure is effected, actual values (e.g. actual sale price) are entered into the system, and the user (agent, broker, lender) may access screen interface shown in FIG. 2, and click on the actual value screen by selecting the program phase selector button 130 to indicate to indicate “actual”. In response, the screen interface depicted in FIG. 2 will be provided and automatically populated with actual values based on the final sales and equity contribution calculations performed after “actual” values are entered into the system. It should be understood that the system contemplates for adjustment calculations at this step, e.g., if the foreclosed home sales price comes in for more than system specified “over tolerance” values, this may allow for higher GPI (goal purchase increase) rating or a lower DTI ratio for the customer. FIG. 2 will automatically be updated with the actual values. The alternate would apply if the house is sold at a lower price.

FIG. 2 further depicts via screen interface 100 further information for determining the customer's AF rating. Particularly, a user (lender, agent, broker) elicits information from the customer and enters it directly into the system, or, the data may be directly entered into the system by a customer via provided by a computer device. As shown, information including the customer's actual monthly expenses 140 including credit card expense, auto payment expense, mortgage/loan repayment, property tax, home owner's insurance. A total current monthly expense is calculated and a field is populated via interface 100 with the customer's estimated current monthly expense 143. Further entered into the system is the customer's current monthly income into entry field 145 which total value populates a field 147 via interface 100. It should be understood that some of the information to be filled in the AFQ may be completed by a borrowers who chose to participate in the program, in advance. Alternately or, in addition, the information may be separately obtainable via available credit rating services.

According to the invention, based on the entries entered and populated fields in the interface 100, the system performs a calculation to associate the customer user an AF rating. This AF rating value is populated in field 150, of screen interface 100 of FIG. 2. From this AF rating, a user may be placed in an improved financial situation as a co-owner of a house (two-family, multi-family dwelling, for example), as the rating is used to categorize that customer and other potential co-owners (candidate partners) and facilitate conducting an investigation into a pool of available partners most advantageously poised to conduct the subsequent home purchase transaction with the customer, if there is a match, as will be explained in further detail herein. This interface will be presented to a user (lender, agent, broker) in an estimation phase of the program.

Via this estimation phase of the program, a customer will be apprised of the various purchase options based on the contents of the pool of potential partner candidates based on their AF rating and their equitable contribution affordable.

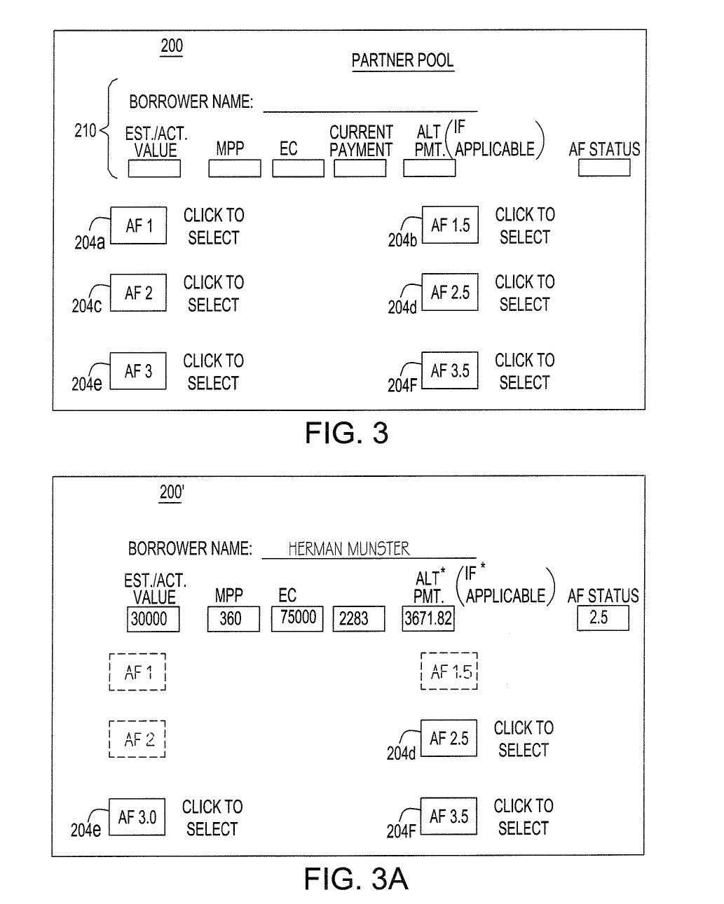

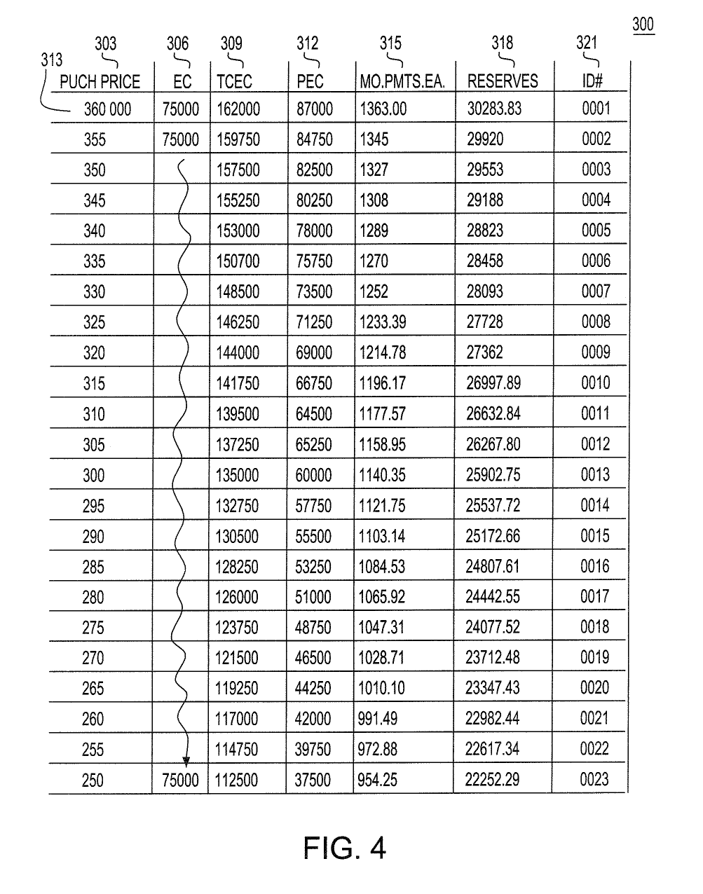

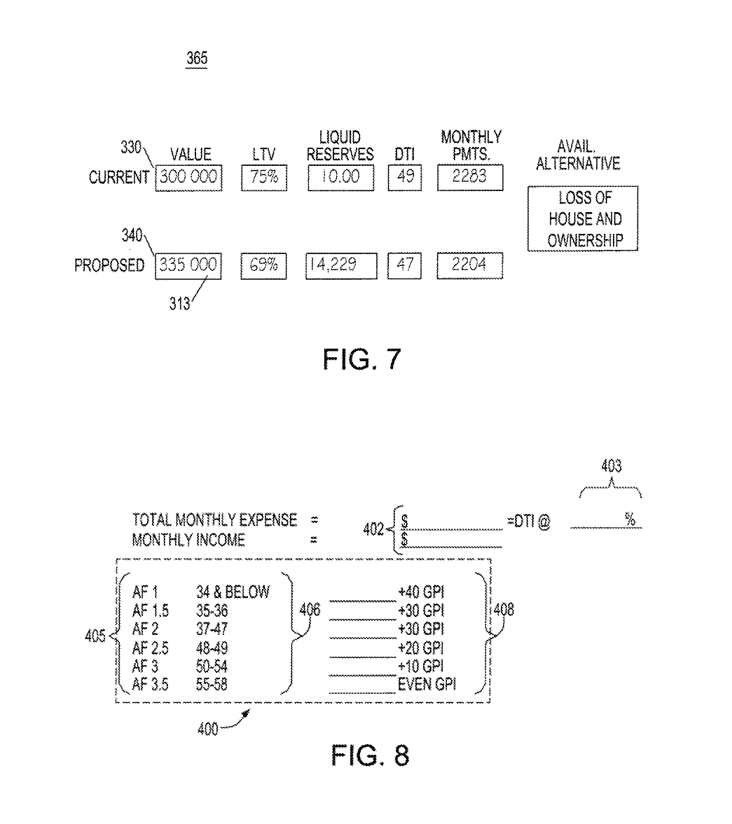

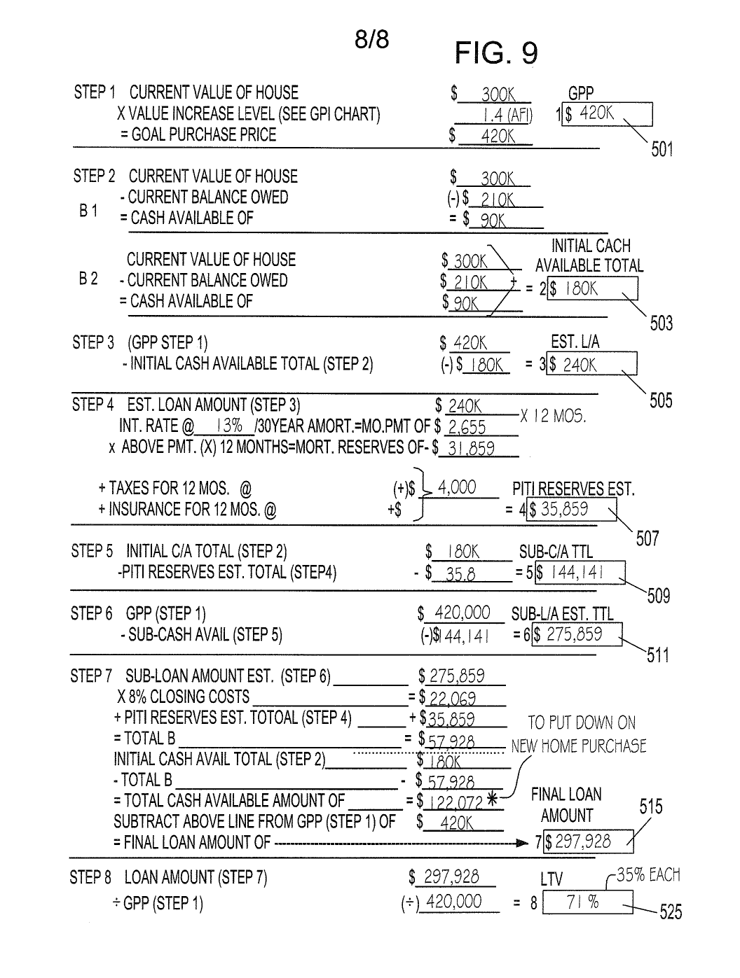

As will be described in greater detail herein below in connection with FIG. 3, the AF ratings used in categorizing the debtors comprise values AF-1, AF-1.5, AF-2.0, . . . , AF-3.5. The system further correlates each of these ratings with a unique percentage value indicating a potential purchase price range for a new home for that customer according to the program. Details regarding the determination of the AF ratings and other formula and calculations applied according to the principles of the implemented program and executed by a computer-implemented system are described herein below with respect to FIGS. 8-9. Key to this determination is to structure the affordability factor and goal purchase price range so that the debtors are always at a LTV and DTI ratio assured to entice a lender into lending to the debtors, notwithstanding their foreclosure situation.

It should be understood that a customer will be considered qualified to take advantage of the methods and system of the invention based on a criteria such as the customer's current LTV (loan to value) ratio that would ensure a lenders' participation as described herein. Thus, returning to FIG. 1A, once qualified to participate in the program at step 19, according to the program, the system then calculates for the customer a Goal Purchase Price (GPP) range indicating potential home purchase value options as a co-owner with another party that customer. More particularly, based on the AF rating calculated from the information entered into the system, the customer's purchasing options are determined, and a calculation is performed to initially classify the customer with a goal purchase price (GPP) range which comprises the customer's current estimated home sales value plus (+) and minus (−) a determined percentage correlated to their AF status. The GPP value plus (+) the determined percentage is referred to as the maximum GPP value (MPP), which value is populated in field 160, of screen interface 100 of FIG. 2. Once qualified for the program, the customer/borrower enters a first estimated pool of foreclosures based on the system calculations such as shown in FIG. 1A at step 22. Particularly, once the AF-rating is assigned for each customer, the system calculates estimated values that determine the home purchase potential for that customer and criteria effecting that purchase, e.g., customer's equitable contribution. The estimated pool will comprise a listing of like customers in similar financially distressed situations, or other investors, with links for accessing, among other things, that customer's AF questionnaire, GPP potential purchase ranges, estimated equity contributions affordable by the customer toward a joint-purchase of a home/property according to the program.

FIG. 3 depicts an example screen interface 200 provided by a computer device implementing the system of the present invention. This interface will be presented to a user (lender, agent, broker) to initiate investigation into the first estimated pool of potential partner candidates based on their AF rating and their equitable contribution affordable and maximum GPP price. As shown in FIG. 3, the critical financial information 210 including that customer's estimated AF rating, EC, MPP, current monthly payments, and the current equity value of the customer (home market value) associated with the customer is presented via interface 200. This data will be presented for all subsequent screens interfaces presented to provide a quick point of comparison of the customer's potential purchase options. Entry into the estimated pool of potential partnering candidates is conducted by the user selecting from one or more entry buttons 204a, . . . , 204f according to the AF rating of the customer, e.g., values AF-1, AF-1.5, AF 2.0, . . . , AF3.5, respectively. The interface 200 of FIG. 3 will be presented for the user for a customer having a AF-1 rating as all entry buttons 204a, . . . , 204f are available for selection. FIG. 3A, in particular, depicts a related example screen interface 200′ presented to the user for the example customer who's debt information has been entered into the AFQ 100 shown in FIG. 2. As shown in FIG. 3A, based on the system calculations, the subject customer has been assigned an affordability factor rating of 2.5 and, consequently, the AF-1, AF-1.5 and AF-2 entry buttons have been grayed out. This means that to match a customer, the user will seek candidate partners in the estimated pool having only a AF_{—}2.5 rating or lower.

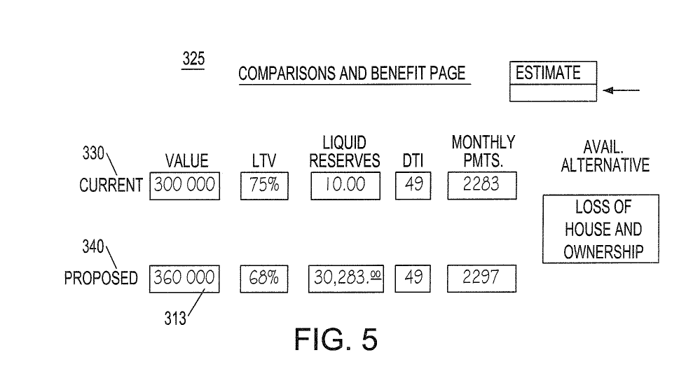

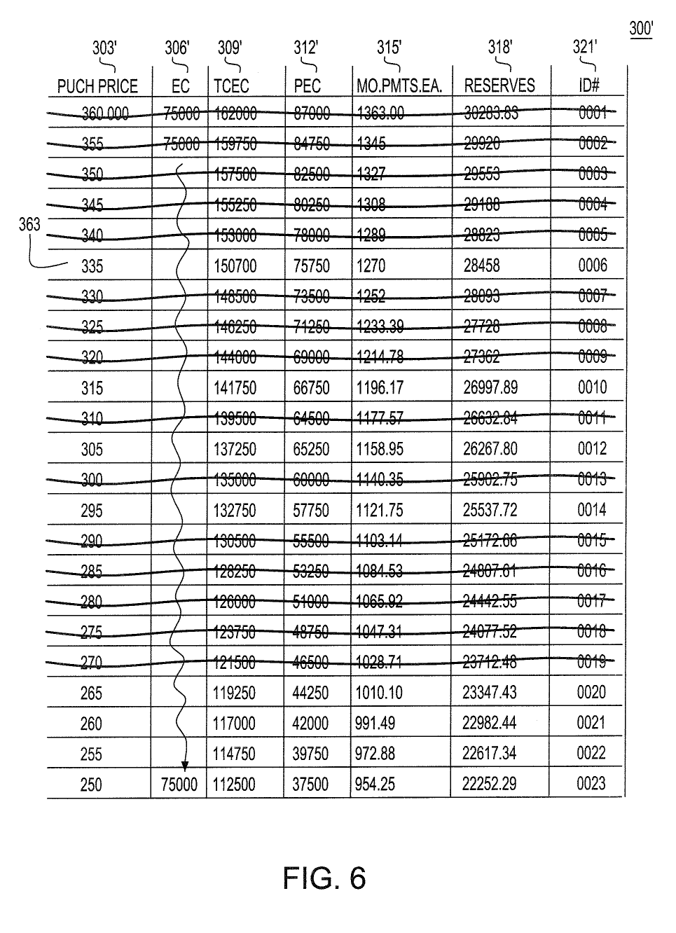

Upon selection of the AF rating entry button from FIG. 3 (or FIG. 3A), a further interface screen 300 is presented as shown in FIG. 4 providing a list of those potential partners that could be matched with the customer based on the AF, GPP EC criteria and, other criteria including a total combined equity contributions (TCEC) criteria which represents the total combined equity contributable by both partners which value is additionally pre-calculated by the system. The example interface 300 shown in FIG. 4 is presented in response to user selection of the example AF-2.5 rated customer by selecting the AF-2.5 entry button 204c of FIG. 3A. A different screen may be presented for each respective AF-rating. As shown in FIG. 4, in each AF-rating screen, the user is able to view those potential partners that would most advantageously match the GPP and TCEC criteria of the current customer for potentially purchasing a new home. That is, as shown in FIG. 4, interface 300 lists those potential candidates including their calculated GPP 303, the customer's current estimated EC 306, the estimated total combined EC (TCEC) 309 of the current customer and that of the potential partner that would be necessary to effect the home purchase at the GPP price of the customer, the potential partner's estimated EC (PEC) 312, and estimated monthly payments 315 that would be incurred by both partner's if a purchase is effected at the selected GPP (purchase price), and an estimated amount of retained PITI reserves 318 that are held back in case of a default by a co-owner after a home is purchased and which can later be used as an asset for the customer. It is understood that while the GPP represents a range of potential purchase prices for that customer, the system will attempt to match that customer with that customer's MPP (maximum goal purchase price. Additionally, associated with the potential candidate list is a suitable identification number 321. Links are provided to a benefits page, as will be described herein with respect to FIG. 5, that automatically presents to the user, in response to selection of a potential candidate, details concerning the estimated potential purchase between the customer and the selected partner and the attendant benefits for the customers.

The EC and TCEC values provided in the interface screen 300 as shown in FIG. 4 are automatically populated by the system. For example, in one embodiment, the system may quickly perform a calculation implementing a pre-determined multiplier value. That is, a multiplier table provided with a pre-calculated multiplier value may be used such that the value, when multiplied by the purchase price, sets the total TCEC value required to conduct a home purchase at the indicated purchase price. Thus, for example, the borrower who seeks to purchase as joint co-owner a property valued at $360,000 purchase price, will require a TCEC of $162,000 according to the respective multiplier value of 0.45, for example. Corresponding multiplier values are consistently the same for a range of GPP's, however, will change as the GPP decreases or increases.

Thus, for example, by selecting a proposed home goal purchase price value, e.g., 313 representing a home purchase of $360,000 via the interface 300 depicted in FIG. 4, a proposed benefits interface screen 325, as shown in FIG. 5, is presented that depicts a comparison of the example customer's current debt information 330, including that customer's current home value, LTV ratio, liquid reserves DTI, and monthly payments, against system calculated values 340 of the same information assuming an example proposed home purchase at the selected purchase price 313. As shown via the information presented by the system in FIG. 5, the customer will have a higher value house with a lower LTV which opens up his options in the near future. For example, that customer will have an additional $30,283 cash available to earn interest for 24 months, for example. That customer's DTI ration has been calculated to current standards. It should be noted that, due to the current DTI and LTV values for that customer, this customer has no alternative action available which will cause the loss of that customer's existing house.

It is understood that, for the scenario where the customer's home has not yet been sold (i.e., the estimation phase of the program), this information calculated by the system can be used to apprise the customer of a maximum goal purchase price with a partner and define for the customer the best case possibilities of what he/she can do.

Returning back to FIG. 1A, at step 25, once entered into the estimated pool, and apprised of the customers potential options for avoiding foreclosure according to the program, and pending their agreement to enter into the program for avoiding foreclosure, the services of a realtor, broker or agent are retained to sell the customer's existing home that is subject to the foreclosure. In one embodiment, when establishing a value for the customer's existing home, the home is “comped” (i.e., a comparable search of other houses in the immediate area of the subject house which recently sold that are the same or close to the customer's existing home style and size). This “comp” represents an acceptable value, usually less than the actual sale of house, currently used by the banks to lend on. According to the program, a minimum sale price for the customer's home is established based on the comp value subject to an additional downside tolerance (e.g., about 15% or less) that would make the foreclosed property more attractive for other parties to purchase and facilitate the sale. Only until the customer's existing home that is subject to the foreclosure is actually sold, as indicated at step 26, will the program proceed to the next steps which entail matching the customer up with the potential partner (party) who has additionally committed to purchasing a new home as co-owner with that customer according to both party's (customer and second borrower) total combined equity contribution (TCEC) that could be applied toward a home purchase of another home/property as co-owners in accordance with the program.

Continuing now to FIG. 1B, at step 30, after the customer's home is sold, data comprising the final home sale of the customer's foreclosed property is entered into the system. The system calculates the final (actual) equitable contribution (EC) value that the customer can commit towards a purchase of another home/property as co-owner with another party. Further, as indicated at step 30, the foreclosure proceeding of the customer's home will be terminated, thus placing that customer on the path to financial freedom. That is, a sales contract evidencing the sale of the customer's existing home, may be sent to the lender, e.g., bank, along with a request to stop the foreclosure as indicated at step 30.

Generally, according to the invention, at the time of sales and signing of contracts pertaining to the existing home sales, the customer/borrower may be eligible for a re-evaluation (RE) to a higher goal purchase increase (GPI) rating. Thus, an optional step may be further implemented that depicts this re-evaluation for upgrading the home purchasing potential of the customer/borrower.

Next, as indicated at step 35, upon sale of the customer's house, the customer is placed into a second pool, which constitutes an actual pool of ready borrowers who may or may not (e.g., an investor) have also sold their foreclosed property and have a determined equity contributable amount to partner up with the customer in a home purchase. According to the invention, this actual pool of borrowers is maintained to provide a source of potential borrowers (partners) that can be matched with the customer, for purchasing another home based on their AF, GPP range, and actual TCEC values. The actual pool comprises all other borrowers having the same or different AF ratings as the customer. As will be explained, the parties are listed in this actual pool because all AF-1 borrowers have the same Debt to Income ratio (DTI) classification. Listing in this actual pool provides the customer and borrower with a first opportunity to buy a house in their affordable range as co-owners.

Then, as shown in next step 37, FIG. 4, the actual purchase options for the customer are now investigated. That is, from data provided in the actual pool, the system will execute methods to perform a matching function that will enable the customer to be matched up with actual partners based on their AF rating and TCEC criteria. These choices will then be presented to the user via an interface screen such as shown in FIG. 6, to view an actual selection of viable home purchase options with a potential partners available in the actual pool that may be automatically communicated to a user for the immediate benefit of a customer.

For example, via the mechanisms described herein with respect to FIGS. 3-4, a screen interface 300′ shown in FIG. 6 is presented for the user (lender, broker, agent) that is similar to the screen interface of FIG. 4 however, represents the source of actual matching partners with all estimated potential partners blacked or grayed out as non-available. That is, as shown in FIG. 6, for each AF-rating, the user is able to view actual partners at that rating that are immediately available to conduct the joint home purchase in a manner that would most advantageously match the GPP and TCEC criteria of the current customer and/or partner. The example interface 300′ shown in FIG. 6 is presented in response to user navigation to an AF-1 rated customer as indicated via the interface 300′. A different screen may be presented for each respective AF-rating to provide only those actual available partners at that AF-rating with all others blacked out. The screen interface 300′ lists actual potential partners including their calculated MPP 303′, the customer's actual EC 306′, the actual total combined EC (TCEC) 309′ of the current customer and that of the potential partner available to effect the home purchase at the GPP price of the customer, the potential partner's actual EC (PEC) 312′, and actual monthly payments 315′ that could be expected to be incurred by each partner if a purchase is effected at the goal purchase price, and an amount of retained PITI reserves 318 that are held back in case of a default co-owner after a home is purchased. Additionally, associated is the suitable identification number 321′ of the customer and partners. Links are provided to a benefits page, as will be described herein with respect to FIG. 7, which automatically is presented to the user in response to selection of a potential candidate to provide details concerning the estimated potential purchase between the customer and the selected partner and the attendant benefits for the customer.

As part of this process, a partner matching algorithm is executed by the system to facilitate matching of one or more potential candidates with the current customer for presentation on the screen interface 300′ of FIG. 6.

That is, for an actual customer in the actual pool, the list of actual partners in the actual pool is sorted in a manner such that the customer may be matched with a partner initially at the same AF-rating, i.e., AF-1 rated customer with an w/AF-1 borrower, AF-1.5 w/AF-1.5, etc. For each of these partners found in the actual pool, the system automatically performs calculations for determining whether an actual EC of the customer and the actual EC of those like AF-rated pooled partners can meet the total TCEC requirement for a home purchase at the maximum goal purchase of the customer. It is understood that the TCEC requirements will vary for different AF ratings. That is, the matching function is executed to determine a partner for that customer that will maximize the customer's TCEC requirements for purchasing a home, as a joint- or co-owner, priced initially at the MPP price of the customer. If no partners are found at the MPP price, the same calculations may be performed to find partners at a lowered GPP price within the calculated GPP range for that customer. For each of these partners found in the actual pool, the system automatically performs calculations for determining their contributions and populates the fields accessible via the example interfaces of FIG. 6 and benefits page shown in FIG. 7. Otherwise, if no partners can be found, the list of partners in the pool is traversed to located those potential partners assigned a lower AF-rating, to determine a partner for that customer. In this matching phase, the system seeks a potential partner(s) that will maximize the partner's requirements based on purchase price and TCEC requirements commensurate with the other borrower's lesser AF rating value that will maximize the lesser AF criteria, i.e., TCEC requirements for purchasing a home, as a joint- or co-owner, not the customer's. This would comprise a search for MPP prices of the pooled partners within or below the GPP range of the customer. For each of these partners found in the actual pool, the system automatically performs calculations for determining the contributions and populates the fields accessible via the example interfaces of FIGS. 6 and 7.

Thus, for example, once a partner is chosen by selecting a proposed home goal purchase price value, e.g., 363 representing a home purchase of $335,000 via the interface 300′ depicted in FIG. 6, a proposed benefits interface screen 365, as shown in FIG. 7, is presented that depicts a comparison of the example customer's current debt information 370, including that customer's current home value, LTV ratio, liquid reserves DTI, and monthly payments, against system calculated values 380 of the same information assuming an actual home purchase conducted with that partner at the selected purchase price 363. As shown via the information presented by the system in FIG. 7, the customer will have a higher value house with a lower LTV which opens up his options in the near future. For example, that customer will have an additional $30,283 cash available to earn interest for 24 months, for example. That customer's DTI ratio has been calculated to current standards. It should be noted that, due to the current DTI and LTV values for that customer, this customer has no alternative action available which will cause the loss of that customer's existing house.

Next, returning to FIG. 1B, at step 39, a determination is made as to whether a partnership match can be made within another borrower in the actual pool. Only until a match is made, as determined at step 39, will the process proceed to step 42 that embodies the next step of searching for a house for the customer and the matched borrower to purchase for the customer and the matched borrower according to the TCEC requirements of either the customer or the matched partner.

According to the principles of the invention, this potential purchase property is a one-family, but most likely, a two-family or even a multi-family dwelling and the original borrower and matched partner may, but not necessarily have to, live at the dwelling. As will be described in greater detail below, based on the partners actual AF rating, actual EC and actual PEC values, the partners will be considered equal partners (EP), i.e., ones that may be an equal contributors (in terms of equity contributions from each) and thus become an equal equity co-owner of the new dwelling purchase, or, non equal partners (NEP), i.e., a non-equal equity contributor.

Preferably, the user (lender, broker, agent) will access a realtor having an inventory of homes for sale in the preferred geographic location indicated by the customer in the AFQ to search for a home to be purchased. Alternately, the user or system may access an available inventory of homes for sale in the preferred geographic location. Thus, a search for a house is initiated preferably in the desired geographic location indicated by the customer (or matched partner, if customer agrees), which may be in or near the community where the customer currently resides, or in an entirely different geographic location altogether. It is understood that a desired geographic preference for the home purchase according to the program may be received from the customer as one of the responses to the initial completed AFQ.

Continuing next to step 45, FIG. 1B, the method step represents the matched borrowers' joint purchase of the single- or two-family or multi-family home in accordance with the customer's TCEC, GPP and other system calculations commensurate with the program and governing laws and regulations. Afterwards, the various real estate purchase contracts for purchase may be drawn for the parties as co-owners, assuming lender participation, to effect a purchase once a home suitable for the customer and partner is found.

The following describes example foreclosure avoidance/home purchase scenario via the estimation phase of the program implemented by a lender, broker or agent, and example calculations made by the system for the estimated and actual partnering phases of the program according to the principles of the invention. It is understood that, from the answers provided by an example customer, via the example interface 100 depicted in FIG. 2 presenting the AFQ, certain calculations are performed to determine customer's eligibility to participate in the program of the present invention and, their immediate options for avoiding foreclosure.

As shown in FIG. 8, the calculations are implemented as part of the process described herein with respect to FIG. 2 to establish the customer's AF rating, particularly based on that customer's current debt to income (DTI) ratio. That is as shown in FIG. 8, the system receives data from the customer responses from questions that elicit current monthly expense amounts, current monthly income amounts 402 for the customer, and from the answers provided to the AFQ (whether estimated or actual values), determines the borrower's current debt to income (DTI) ratio 403. Then, as shown in FIG. 8, the system, via automated table look-up function, associates an AF-rating with the determined DTI for that customer. For example, an AF-1 rating will be assigned to those customers that are at a DTI of 34%, or below. A DTI ratio of 34% or below, which, in the exemplary scenario, corresponds to a borrower's current earning, e.g., $4,000 with obligations at $1,000 on a monthly basis. The table 400 such as shown in FIG. 8, illustrates example assignable AF rating values 405, e.g., AF=1, 1.5, 2, . . . , 3.5, etc., each AF value corresponding to a respective DTI value 406 calculated for the customer. For example, an AF 1.5 rated borrower has a calculated DTI ranging from 35-36 while an AF 2.5 rated borrower has a calculated DTI ranging from 48-49. This table is present in the system and used in the computer-implemented processes.

As further shown in FIG. 8, the table 400 generated by the system further correlates the customer's AF rating with a goal price increase value (GPI) 408 that is used to establish a goal purchase price range indicating that customer's home purchasing potential. That is, the customer is initially classified with a goal purchase price range (GPP+) to (GPP−) based on their AF percentage. For example, an AF1 in an example embodiment represents that a borrower's GPI value of 1.4 increase is a percentage, e.g., +40% (a multiplier equal to 1.4). This value would constitute a maximum goal purchase price for that AF-1 rated customer. The AF1 rating assigned to a customer with a low DTI ratio means that the borrower will be able to afford, according to the program, to buy a house at a goal purchase price range between 1.4 times above and 1.4 times below the current market value of their home to be foreclosed. For example, assuming a current value of the customer's existing home is $300 k, the GPP range for an AF-1 borrower having a GPI of 1.4 or +40%, is calculated as $300 k×1.4=$420 k (=MPP value) and $300 k±1.4=$214 k. That is, a customer owning a $300 k valued home, may conduct a further purchase as co-owner with another of a home ranging in value between approximately $420 k down to $214 k. Likewise, an AF3.5 rating assigned to a customer with the highest DTI ratio means that the borrower will only be able to afford, according to the program, a house at a goal purchase increase equal to the current market value of their home to be foreclosed. For the customer having an established GPI of 1.40 or higher, then given the example purchase scenario described, $300,000, the total value amount multiplied by the correlated GPI value of 1.4 means their goal purchase price (first and second borrowers as co-owners according to the system) can be increased to $420,000. It is assumed that both of these borrowers own a $300,000 house, so the system attempts to match a partner up with the customer in a manner that gives them a better situation, e.g., a two family house that is worth more.

FIG. 9 illustrates a worksheet 500 depicting further types of calculations automatically implemented by the system for avoiding foreclosure at the various estimation and actual phases of the program, and that may be programmed into the system computer device. A user will thus immediately benefit by the system by immediately presenting GUI viewable options for the customer in financial distress based on their AF rating and, presenting various scenarios for avoiding foreclosure that culminate in the purchase of a new home as co-owner with another. The calculations are provided in FIG. 9, are for illustrative purposes and other modifications and variations known to ones of ordinary skill in the art may be employed.

The worksheet 500 depicted in FIG. 9 presents a series of calculations that can be automatically implemented and employed to present estimated and actual information including, but not limited to, values of: the customer's Max GPP 501, an initial TCEC value for two borrowers 503 an initial estimated lender loan amounts 505 for facilitating a joint purchase transaction, an amount of PITI to be held in reserve 507, a sub-cash available total for both partners 509, a sub-loan amount estimate 511, and presents a final estimated load amount 515. The worksheet calculations presented may be used for different scenarios i.e., with partner of different AF-ratings (non-equal partners).

At step 1, FIG. 9, there is particularly shown the calculations implemented for determining the goal purchase price range as explained herein. The upper GPP value is considered the maximum purchase price affordable by the customer and this value is calculated automatically by the system and presentable to a user via an entry field 501 as shown in FIG. 9. In the example provided, assuming a current value of the customer's existing home is $300 k, and the customer is an AF-1 borrower having a GPI of 1.4 (=+40%), the maximum purchase price affordable by the customer is calculated as $300 k×1.4=$420 k.

At step 2, FIG. 9, there is particularly shown the calculations implemented for determining an initial estimate of each customer's initial EC or cash available from each joint partner. This EC may be calculated with knowledge of the estimated current market value of the customer's home and LTV of the customer, or, the difference between the market value of the customer's home (e.g., $300 k) and the current balance owed on the mortgage (e.g., $210 k). From the example values provided herewith (e.g., $300 k and $210 k), the customer's EC is $90 k.

Assuming a potential equal partner (EP), an additional calculation made at step 2, FIG. 9 to determine the cash availability of the second potential purchasing partner. In the example scenario, this information is the same as for the first (EP) partner. Thus, given the example scenario, a borrower wanting to buy a house for $420 k, the partner ideally must be AF-1 rated with $90,000 PEC. The system will populate the total initial cash available field 503 with the estimated TCEC of, for example, $180,000 ($90 k each from equal contributors) in the example provided. Once it is determined what both borrowers have to contribute, i.e., a TCEC value, the calculations are simplified and turned into just one equation.

Thus, both partners enter into the system is the total equity in the house between the two, the total they have to offer, e.g. $180,000 in the example scenario. From herein, the formula is worked out from the TCEC amount, and then after all the calculations are made according to the formulae described herein, the results will be divided by the number of borrowers, two (2) in the example scenario, to get the individual borrower obligations for conducting the new home purchase as joint co-owners. Thus, for example, if both contributed equally, their eventual obligations, e.g., mortgage payments, are going to be equal. If both partners are unequal (NEPs), then it is understood that the percent ownership is unequal and hence, ownership obligations (mortgage and PITI reserves) will be unequal.

As mentioned herein, the customer is entered in the first (estimated) pool with other like AF rated people that have houses on the market for sale (e.g., foreclosed homes) with the same purchase price range (e.g., between $300 k and $420 k using the numbers of the described example. Thus, for the example scenario described herein, the information maintained for the customer in the first pool would include, but is not limited to: that buyer's rating (AF1), a current value (estimated) of $300 k, his GPI of 40% and the customer's estimated equity contribution $90 k. The system will put that customer into a pool of people in that GPP category range $214 k to $420 k, in the example scenario.

Then, once the customer's house is put up for sale and only when the customer's house is sold, the customer's entry in the estimated pool is flagged via the screen interface (not shown) for transfer and entry into the second actual pool as described herein with respect to step 35, FIG. 1B, assuming that customer meets the TCE criteria. When the actual house is sold, the borrower's actual equity information becomes known and this information is now actually exported into the actual pool where that borrower's listing is entered with other borrowers with actual equities available. That is, when exported into the actual pool, other parties will be listed who have already sold their house, within or without the same price ranges (e.g., $300 k to $420 k), and who will have an EC that can be used for the purchase of a house as joint owner with the customer. Preferably, the customers in the pool will comprise borrowers within a range of AF factors and EC amounts and a geographic preference. In the example scenario, the ideal equal partner match-ups in the pool will be borrowers having AF-1 ratings looking to buy a home at a similar max GPP value or within the GPP value range as the example customer ($214 k to $420 k) and, with an EC of at least at $80,000 as in the example scenario. Other factors may be used to match-up partners including their geographic preference, or other individual preferences if stated, e.g., preference for owning pets, etc. The system's matching functions will match the customer with a borrower that meets that equity contribution, TCEC, Total Combined Equity Contribution as described herein with respect to FIG. 6.

As mentioned, a matched partner may be of equal or unequal status. An example for matching the customer with a borrower of unequal status is now provided. In one example, it is assumed a customer A's home is $300 k and is AF1 rated having a max GPP of $420 k and a total EC of $60 k and a total TCEC=$180 k. An NEP, customer B, may also have a $300 k value home and is AF1 rated having a max GPP of $420 k and a total EC of $120, with a TCEC=$180 k. Then customer's A and B are NEP based on their Equitable Contribution. In one embodiment, a tolerance of, for example, $10,000 tolerance (+) or (−), may be built into these calculations.

If a customer needs a $180 k total contribution, and a pre-determined allowance, e.g., $10,000, is given, a customer that has an EC of $80 k, and another borrower that has an EC of $100 k will be considered equal partners. Anything below that, a customer EC of $70 k and the other borrower has a $110 k EC, then they are not equal partners and the first customer will take less ownership in the house eventually purchased.

Returning to the worksheet of FIG. 9, at Step No. 3, there is computed an estimated loan amount for conducting the joint home purchase transaction. This value is estimated as the max goal purchase price (GPP) value of the customer as calculated in Step no. 1 reduced by the TCEC amount (both partner EC contributions). In the example scenario, the value calculated is as the estimated initial loan amount to conduct the purchase transaction for both co-owners is, e.g., $420 minus the $180 ($240,000). The system will populate the estimated loan amount value in field 505 via the interface shown in FIG. 9, which value provides the estimated loan amount value from which the remaining calculations is based.

At next Step 4 of FIG. 9, there is estimated the Principal, Interest, Tax and Insurance (PITI) reserves for the borrowers which value is based on an estimated loan amount value calculated in Step No. 3, the current interest rate applicable to that borrower, the term amount of months, and estimated taxes and insurance costs. First, a current monthly mortgage payment is calculated and the value multiplied by 12 to obtain a yearly amount of mortgage payments for both borrowers. Then there is provided an estimated taxes and insurance costs which totaled with the yearly mortgage payments comprise the amount of amount of PITI reserve held back to guarantee payment at least through the first year. In the example scenario depicted, based on a prevailing interest rate of for example, at an example interest rate of 13% (this amounts to an effective rate 6½% for each borrower) or higher or lower rate as may be the case, and given the $240 k estimated loan amount, and given an example 30 year mortgage term, there is calculated an monthly payment of approximately $2,655 the estimated monthly payment total for both borrowers. Plus, there is further established an additional monthly payments that would accumulate to a predetermined amount of reserves. The formula additionally figures in a guaranteed one-year payment to the bank based on this monthly loan amount. For the example purchase, a guaranteed yearly amount is determined according to the 2,655 multiplied by 12 which value (=$31,859) plus the estimated taxes for one year (12 months) and estimated insurance payments (for 12 months) are also calculated and added to the $31,859 guaranteed yearly amount be populated in PITP reserves value field 507 shown in FIG. 9 (a total of $4,000 for the taxes and insurance was added for illustrative purposes to make a total of $35,859) PITI reserves estimate.

In accordance with Step no. 5, this PITI reserve amount is then subtracted from the TCEC value (initial cash available value), to be put on the side. In the illustrative example, the remaining balance would be the total cash available to put down on the new house purchase for the first and second borrowers as co-owners (cash available is $144,141 for the example described=$180 k−$35,859). The system will populate the new total estimated cash available amount in field 509 via the interface shown in FIG. 9.

Thus, the system ensures that for one year, the joint purchasers have their mortgage payments and their taxes paid only if necessary. In one year, if they make their mortgage payment on time their initial interest rate of 13% could be reduced. Thus, the system guarantees that these borrowers that are in foreclosure, their effective rate is $6½, and reserves are going to be put in the bank so that at least one year of payments will be payable.

Further, as shown in FIG. 9, at step 6, a calculation is performed for calculating an estimated sub-total loan amount which would comprise the MPP value from which value is subtracted the total sub-cash available calculated at step 5. This value ($420 k−cash available is $144,141 yields $275,859 new estimated loan amount. The system will populate the new estimated loan amount value in field 511 via the interface shown in FIG. 9, which value provides the new estimated loan amount value from which the remaining calculations is based.

Further, as shown in FIG. 9, at step 7, the estimated closing costs are determined and pulled into a calculation for determining a new total cash available (TCEC) amount. This amount represents the final amount of money the borrowers have left over to put down on the home purchase based on the sub-loan amount estimation calculated in Step 6, the PITI reserves calculation in Step 4, the initial cash available total from step 2, and estimated closing costs step 7. The closing costs are established by based on the sub-loan amount, (=$275,859) and this multiplied by 8% or as may be customary in the industry. In the described embodiment that value is calculated $22,069. Given the numbers in the example scenario provided herein, and assuming closing costs estimated at 8%, a new total cash available (TCEC) amount is determined to be approximately ($122,072). Then, a calculation is performed to determine a final loan amount, which would comprise the MPP value ($420 k) minus the new total cash available calculated. This MPP value ($420 k)−cash available ($122,072) yields $297,928 final loan amount. The system will populate the new final loan amount value in field 515 via the interface shown in FIG. 9. This amount of $297,928 is going to be the new loan amount by a lender for both borrowers as co-owners.

In short, the program enables the two borrowers, to use their equity, and after taking out a tolerance amount (PITI, closing costs, etc.) use the rest to put down as a down payment on the new purchase price property, at the GPP value.

Next, at Step no. 8, FIG. 9, the LTV rate calculation is made as comprising the final loan amount (e.g., $297,928) divided by the GPP of $420 k, which comes to an LTV of 71%, which is effectively 35% each. This may be acceptable to a lender, or the numbers may be tweaked to bring the LTV ratio to an acceptable value for a lender. The system will populate the new LTV amount value in field 525 via the interface shown in FIG. 9. Current lenders' (banks) guidelines will make loans to 70%, 71% LTV borrowers. That is, in comparison with the borrower's original status, the borrower originally entered the system at 70% and now between the two of them, they're at 35%.

Thus, in the example scenario, if a broker or realtor had a customer that wanted to buy a $420 k house, based on the calculations herein, the parties would have to have $180 k in cash available because it brings the LTV low enough. If they only had a combined $160 k in cash available, it would bring that LTV up to 75% and the lender may not perform the loan.

Additionally, the $180 k calculated according to the formulae presented, will keep both borrowers' debt ratio where it needs to be in accordance with the current lending guidelines. Further, as that down payment, the Total Combined Equity Contribution (TCEC) is the key to determining how borrowers may be matched, according to a further embodiment of the invention, the system stores and maintains pre-determined results of calculations by performing the worksheet depicted in FIG. 9 for each MPP (of GPP purchase price range) and AF rating combination to ensure maintenance of the acceptable LTV ratio, and are tabulated for storage in the system database for implementation in the calculations performed which results are presented via the interface screens shown in FIGS. 4 and 6 for instance. Thus, a chart or table may additionally be maintained and accessed by realtors/brokers to determine a total equity contribution given the market value of the home to be foreclosed (sold) and the borrower's AF-rating, e.g., $300 k, $310 k, $315 k, $320 k, for all conceivable home values. From this knowledge, it is readily found out how much TCEC cash has to be available. The GPI multiplier facilitates the calculations so it may be readily determined by a table look-up call or like database access procedure a borrowers' approximate total equity contribution would be given the market value of the home to be foreclosed (sold) and the borrower's AF1. Thus, for an example goal purchase price (GPP) of $420 k performed by a borrower having an AF rating of AF1, then the multiplier 0.44, which gives a total of about $184,800 which amount would be the TCEC value.

It is understood that, according to the system and methods of the present invention, contracts between borrowers are drawn and executed borrowers matched up through program's contacts are binding. It is understood that all existing laws and rights that are currently in effect and govern joint partner home ownership, will be the same for the program's customers/borrowers.

A contract may include one standard in the industry to include provisions of rights agreed upon by both parties and may include: borrowers rights to refinance, right to sell: must be agreed upon by both borrowers; and, a right to perform home improvements. Further, the parties may agree upon who will be living at the home and stated in contract that must follow current occupancy laws. All these rights must be agreed upon by both borrowers. Ownership status should be stated in contract base on NEP or EP. The more one borrower puts down the more ownership obtained; otherwise, everything else will be equally split.

Additional provisions governing the contract the parties will be bound to address: the provision of the one year's worth of guaranteed mortgage and tax (PITI) reserves which can be held in interest bearing account; the provisions concerning escrow funds, e.g., after 24 moths of on-time payments, escrow's can be released. Optionally, the escrow funds can not be released anytime sooner except if needed for payments; and optionally the escrow money is released based on EP or NEP status of the parties; default provisions that take effect after a pre-determined amount of time if any borrower becomes delinquent in payments; default clauses for loss of ownership, loss of any monies used out of reserves and, any eviction monies used out of the reserves for covering a borrowers portion of the payment until a “new” borrower is found and after legal fees are paid, etc.; and, in the case of default of one of the parties, a provision specifying that the borrower in good standing has an option to retain house as sole owner or seek out a new borrower that preferably has entered into the program through a broker. Such a clause may govern the situation if borrower retains house he/she may use the reserves to make payments and perhaps then refinance at lower payments into a better situation (albeit not a “best” situation as would be with the partner). It may be further negotiated that, if a borrower wants to seek out new borrower he then calls a broker to find someone and after a new borrower is found, the new borrower must put up 12 months reserves in escrow that cannot be touched for one year, for example.

In another alternate embodiment of the invention, for example, if the timing of a customer foreclosure situation permits, and assuming partners can be promptly found, the system is adapted to enable a re-purchase of that customer's (or partner's) currently foreclosed existing two- or multi-dwelling residence with the joint partner in accordance with the system calculations, if the customer and partner meet the system's criteria for re-purchase.

That is, returning to the series of steps bridging FIGS. 1A and 1B, it is understood that the same customer's property or dwelling that had been subject to foreclosure (and not yet sold) may be the potential property available for the customer borrower to re-purchase as a joint owner with the matched EP or NEP party. Thus, although not shown, a further determination may be made as to whether either borrower, the customer/borrower or the EP or NEP partner, owns an existing multi-family home that is or will be imminently subject to a foreclosure. If either borrower owns an existing two-family or multi-family home, according to the invention, the proposed matched up borrowers can repurchase that existing house according to the system calculations described herein as long as the TCEC requirements for the re-purchase are met according to the program. Otherwise, if neither borrower is a multi-family home owner, the sale of the customer/borrower's existing house will be initiated by a realtor or like agent associated with the bank/broker, as indicated at step 25, FIG. 1A, prior to commencing a search of new house as a co-owner. More than likely, however, the joint purchase of a new house by the customer/borrower and EP or NEP is contingent upon the sale of the customer/borrower's existing house, and only when the existing house has been sold, a search for a home purchase will then be pursued and the foreclosure proceeding be terminated.

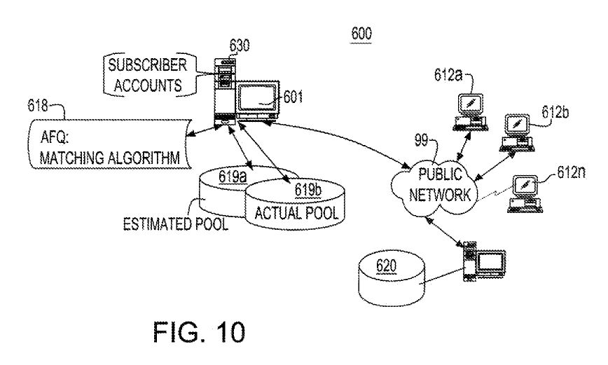

FIG. 10 depicts a diagram illustrating an Internet/Web-based communications system 600 in which the present system and method according to the invention may be implemented. As shown in FIG. 10, the invention comprises a web site 601, or a networked processing node or a standalone work-station or like computing device, maintained and operated by a lender, e.g., bank, or mortgage broker or agent, and accessible via a secure on-line connection service over the Internet, or through a private network or intranet. The standalone work-station includes one or more web/database servers 630 comprising a program or application processing and computer-implemented software components and procedures 618 for storing/presenting the AFQ questions to be used for presentation to users to ascertain their AF ratings and, for executing the various formulae described herein for assigning AF factors, GPP ranges, and EC values required according to the invention. Registered subscribers/users 612a, . . . , 612n of the web site, which may be lenders or mortgage brokers, etc., are enabled to access the web site 601 remotely via wired or wireless connections to the Web/Internet 99 and received the various screen interface displays as described herein. Wired communications between the web site 601 and the users are via the public Internet in accordance with standard TCP/IP protocols and optionally, over a secure communications link, e.g., secure sockets layer, BlueTooth or similar protocol. It is understood that parties 612a, . . . , 612n may access the Web/Internet via a personal computer/computing device, personal digital assistant, or like device implementing web-browser functionality, e.g., Netscape® or Internet Explorer®, or other browsing technology that may be compatible.

The web-site 601 may comprise one or more web-servers 630 executing a collection of web-based applications implementing, for example, Active Server Page (ASP), JavaScript, HTML, VB Script with a SQL Server database or equivalent technology currently in use. This preferably operates on a centralized server and database with suitable security. Provided at a web-site server 630 are various Internet Information Services (IIS) which are mechanisms enabling files on a computer to be read by remote computers and particularly, used to house, secure and present a web site to either the Internet or an intranet (private network); and Component Services (COM) which function as a repository of custom Dynamic Link Libraries (dll's) that allow custom applications to perform actions in data sources foreign to the application, e.g., enabling a web page to query data on a database, which may comprise a home inventory database, for example, maintained by a real estate company/broker/agent.

As shown in FIG. 10, a centralized memory storage device, which may comprise volatile or non-volatile storage, in electronic, magnetic and/or optical media, may be partitioned into appropriate databases including a database (not shown) for storing respective profiles of the registered subscribers, e.g., mortgage brokers, lenders and their various departments, and, a database 619a and 619b including respectively, the first estimated pool of customers and second actual pool of customer listings, and their associated demographic information. In a non-limiting example, a mortgage broker's database (or a lender's (e.g., bank) database available to the mortgage brokers) is maintained and utilized for providing the estimated and actual customer/borrower pools described herein. It is understood that the size and composition of these pools may vary according to physical memory storage requirements and maintenance and/or subscription costs as would be known to those skilled artisans. As described herein, the available home purchase inventory is available from, but is not limited to, the bank's own inventory portfolio of foreclosed, pre foreclosed, and in process of foreclosure houses; however, it is understood that any form of available housing resources, i.e., realtors, FHA, HUD, new construction, etc. may be used. A lender, broker or agent may maintain or access these housing inventory (home listings) resources from its own or another's database 620 for facilitating the search for the home. For example, a bank's agent engaged to search out potential homes for purchase by the customer and joint owner partner may access a bank's or other publicly available database available via the Internet 99, via a network connection, or, alternately or in addition, via computing device 12 equipped with a web browser, for example. Currently, a banks' database have hundreds of thousands of foreclosure homes which are made available to mortgage brokers and other banks.

Thus, as mentioned, the method is designed such that the new equity owning situation is attractive to lenders, banks, and financial institutions to participate in providing financing for the parties through the reduction of loss mitigation engendered by the invention. For example, by the lender's offering the services afforded by the system of the present invention, a new profit producing work force will be necessary. This new work force will be cost effective because they will replace or reduce the need for loss mitigation. The banks have an incentive to implement the system and method of the invention as the system will insure additional profits to the bank by greatly reducing the losses through the reduction of loss mitigation. Additionally, the banks may retain the services of or employ a realtor of their own, because, by doing so, they will also profit from the potential sales fees and purchase fees.

Other types of parties that stand to benefit from implementation of the program include financial advisors—e.g., to invest the PITI reserves; new home builders; contractors. That is, the program of the invention is designed to put a tremendous amount of money back into the economy and change banking guidelines for the good, effectively enabling others into this market. The entire construction industry, material suppliers, manufacturers, transporters, and government programs all additionally stand to benefit from the invention.

It is understood that many variations are possible and the system and method of the invention is further adaptable to market realities and regulatory changes.

The present invention has been described with reference to flow diagrams and/or block diagrams of methods, apparatus (systems) and computer program products according to embodiments of the invention. It will be understood that each flow and/or block of the flow diagrams and/or block diagrams, and combinations of flows and/or blocks in the flow diagrams and/or block diagrams, can be implemented by computer program instructions. These computer program instructions may be provided to a processor of a general purpose computer, special purpose computer, embedded processor or other programmable data processing apparatus to produce a machine, such that the instructions, which execute via the processor of the computer or other programmable data processing apparatus, create means for implementing the functions specified in the flow diagram flow or flows and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flow diagram flow or flows and/or block diagram block or blocks.

The computer program instructions may also be loaded onto a computer-readable or other programmable data processing apparatus to cause a series of operational steps to be performed on the computer or other programmable apparatus to produce a computer implemented process such that the instructions which execute on the computer or other programmable apparatus provide steps for implementing the functions specified in the flow diagram flow or flows and/or block diagram block or blocks.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

Having thus described my invention, what I claim as new, and desire to secure by Letters Patent is:

1. A method of providing financial services for a financially distressed borrower entering or who have entered into a foreclosure proceeding or are about to enter into one, said method comprising:
assigning an affordability factor for a first borrower indicating eligibility to receive said financial services, said affordability factor linked to a goal purchase price range of new homes to be purchased;
causing placement of said first borrower's foreclosed property up for sale based at a price when said first borrower meets a threshold eligibility to receive said financial services;
and, upon sale of said foreclosure property, and based upon said foreclosed property sale,
determining a first actual equitable contribution afforded by said first borrower for purchasing a home within a pre-determined goal purchase price (GPP) range calculated according to said assigned affordability factor and current home property value; and,
matching the first borrower with a second borrower available for entering into a joint ownership home purchase transaction of said new home with said first borrower and providing a second actual equitable contribution, said matching based on said assigned affordability factors of said first and second borrower and a total combined first and second actual equitable contributions by said first and second borrowers; and
initiating a joint ownership purchase transaction for said new home between said first borrower and matched second borrower at a home price within said goal purchase price range using said total combined actual equity amount.

2. The method of claim 1, further comprising halting a first borrower's foreclosure proceeding upon signing of a sales contract indicating final sale of said foreclosed property.

3. The method of claim 2, wherein prior to said assigning, calculating said affordability factor for said borrower based on that borrower's debt to income ratio.

4. The method of claim 3, wherein said calculating said affordability factor rating of a first borrower comprises:
calculating, by a computing device, a debt to income (DTI) ratio of said first borrower according to data entered into said computing device; and,
correlating, by said computing device, said DTI with an affordability factor for association with said first borrower.

5. The method of claim 4, further comprising:
correlating said affordability factor with a goal purchase price increase (GPI) multiplier value for use in calculating a goal purchase price (GPP) value range, said GPP value providing an upper limit of affordability for said joint purchase and ownership arrangement, and,
calculating said GPP range according to:
GPP=GPI×value based on a market value of said first borrower's foreclosure property,
wherein an estimated loan amount to be provided by a lender is determined from said GPP range.

6. The method of claim 5, further comprising:
listing said first borrower in a first pool of potential borrowers seeking co-ownership of a property with said first borrower, and for each borrower in said listing, presenting assigned AF factor, calculated GPP range and estimated equity contribution (EC) value affordable for the home purchase;
determining a potential matching partner from said first pool for a home joint purchase with said first borrower based on said GPP range, estimated EC value, combined estimated total EC value contributable by said first and second borrower (TCEC); and,
presenting the potential matching second borrower to a first borrower and attendant financial benefits for said first borrower if matched with that second borrower at the estimated TCEC value.

7. The method of claim 6, wherein after said first borrower's foreclosure property is sold,
removing said first borrower from said first pool listing and placing said first borrower in a second pool listing comprising like second borrowers who have already sold properties, and seeking co-ownership of a property with said first borrower, and for each borrower in said second actual listing, presenting assigned AF factor, calculated GPP range, actual equity contribution (EC) value affordable for the home purchase, and, total combined EC value contributable by said first and second borrower; and,
determining a potential matching partner for a home joint purchase with said first borrower based on said GPP range, actual EC value, and, total combined EC value contributable by said first and second borrower.

8. The method of claim 1, further comprising for said joint ownership purchase transaction:
executing an algorithm for determining a final loan amount to be financed by a lender for conducting said joint ownership purchase transaction for said home, said final loan amount based on said first and second borrowers' respective determined total actual equitable contributions and said GPP range.

9. The method of claim 7, further comprising providing for a mortgage broker access to said second pool listing to facilitate said matching of a second borrower with said first borrower whose foreclosure property has been sold.

10. The method of claim 9, wherein said calculated AF factor and GPI rating is such that ensures each borrower's loan to value (LTV) for conducting said joint ownership purchase transaction for said home is within a range suitable for a lender to lend on.

11. A method for selling a home comprising:
accessing a pool listing foreclosure homes of borrowers, said pool comprising information records of first borrowers including an associated affordability factor (AF) rating based on their current credit rating information and home foreclosure information regarding their homes entering or that have entered foreclosure proceedings;
comparing said AF rating for a first borrower against pre-determined eligibility criteria for determining eligibility for receiving financial services for selling said foreclosed home of said first borrower and, for purchasing a new home within a goal purchase price (GPP) range based on said AF rating; and,
upon selling said foreclosed home of said first borrower, matching said first borrower with a second borrower for purchasing said new home within said GPP range as a joint co-owner according to said AF rating.

12. The method for selling a home as claimed in claim 11, wherein said predetermined eligibility criteria comprises:
a goal purchase price range determined for said first borrower for purchasing a said home based on said AF rating and on a sale of said foreclosed home of said first borrower.

13. The method for selling a home as claimed in claim 12, further comprising:
determining an actual total combined equitable contribution (TCEC) value affordable by said first borrower and potential second borrower based on a sale of said house, said GPP, and AF rating, said second borrower being matched according to said goal purchase price and said TCEC value.

14. A program storage device readable by a machine, tangibly embodying a program of instructions executable by the machine to perform method steps for selling a home, said method steps comprising:
accessing a pool listing estimated home purchase prices, said pool comprising information records of first borrowers including an associated affordability factor (AF) rating based on their current credit rating information and home foreclosure information regarding their homes entering or that have entered foreclosure proceedings;
comparing said AF rating for a first borrower against pre-determined eligibility criteria for determining eligibility for receiving financial services for selling said foreclosed home of said first borrower and, for purchasing a new home within a goal purchase price (GPP) range based on said AF rating; and,
upon selling said foreclosed home of said first borrower, matching said first borrower with a second borrower for purchasing said new home within said GPP range as a joint co-owner according to said AF rating.

15. The program storage device readable by a machine as claimed in claim 14, wherein said predetermined eligibility criteria comprises:
a goal purchase price determined for said first borrower for purchasing said new home based on said AF rating and on a sale of said foreclosed home of said first borrower.

16. The program storage device readable by a machine as claimed in claim 15, further comprising:
determining an actual total combined equitable contribution (TCEC) value affordable by said first borrower and potential second borrower based on a sale of said house which determines said TCEC value, said GPP, and AF rating, said second borrower being matched according to said goal purchase price and said TCEC value.
